(19) United States
(12) Patent Application Publication
(10) Pub. No.: US 2010/0177089 A1
(43) Pub. Date: Jul. 15, 2010

(54) GATE DRIVER AND DISPLAY DRIVER USING THEREOF

(75) Inventor: Chun-Yi Huang, Hsinchu City (TW)

Correspondence Address: RABIN & Berdo, PC, 1101 14TH STREET, NW, SUITE 500, WASHINGTON, DC, 20005, US

(73) Assignee: NOVATEK MICROELECTRONICS CORP., HsinChu (TW)

(21) Appl. No.: 12/621,753

(22) Filed: Nov. 19, 2009

(30) Foreign Application Priority Data
Jan. 15, 2009 (TW) 98101445

(51) Int. Cl. G09G 5/00

(52) U.S. Cl. 345/214

(57) ABSTRACT

A gate driver for driving k pixel rows of a liquid crystal display panel, wherein k is a natural number greater than 1. The gate driver includes a shift register circuit and an output logic circuit. The shift register circuit outputs an i^{th} first shift signal and a j^{th} second shift signal in a scan period according to a multiple-level startup signal. The i^{th} first shift signal and the j^{th} second shift signal correspond to the first and second pixel rows, respectively, wherein i and j are natural numbers smaller than or equal to k. The output logic circuit is controlled by a multiple-level output enable signal to provide the i^{th} first and j^{th} second shift signals to drive the first and second pixel rows in a data-input sub-period and a black-insertion sub-period of the scan period, respectively. The data-input sub-period and the black-insertion sub-period are non-overlapped.

This application claims the benefit of Taiwan application Serial No. 98101445, filed Jan. 15, 2009, the subject matter of which is incorporated herein by reference.

### BACKGROUND OF THE INVENTION

1. Field of the Invention

The invention relates in general to a gate driver, and more particularly to a gate driver using a multiple-level startup signal and a multiple-level output enable signal.

2. Description of the Related Art

As is well known in the art, in order to avoid the phenomenon of a motion residual image of a liquid crystal display, the overdriving technology is widely applied to the reduction of the motion residual image of the liquid crystal display. However, the current overdriving technology needs the provision of the large-capacity frame buffer for the operation of the information of the front and rear frames. Thus, the cost of the liquid crystal display is high. Therefore, it is an important subject in the industry to design a method of driving the liquid crystal display and capable of effectively solving the phenomenon of the motion residual image of the liquid crystal display.

### SUMMARY OF THE INVENTION

The invention is directed to a gate driver controlled by a multiple-level startup signal and a multiple-level output enable signal to provide a first set scan signal for controlling writing of data and a second set scan signal for controlling writing of black insertion data. Compared with the conventional gate driver, the gate driver of the invention has the low cost and can flexibly adjust an insertion ratio of black image data to advantageously solve the phenomenon of the motion residual image of the liquid crystal display.

According to a first aspect of the present invention, a gate driver applied to a liquid crystal display panel is provided. The gate driver is for driving k pixel rows of the display panel, wherein k is a natural number greater than 1. The gate driver includes a shift register circuit and an output logic circuit. The shift register circuit outputs an i^{th} first shift signal and an j^{th} second shift signal in a scan period in response to a first startup signal and a second startup signal. The i^{th} first shift signal and the j^{th} second shift signal respectively correspond to a first pixel row and a second pixel row of the k pixel rows, wherein i and j are natural numbers smaller than or equal to k. The output logic circuit is coupled to the shift register circuit and controlled by the first and second output enable signals to provide the i^{th} first shift signal as a first scan signal for output in a data-input sub-period of the scan period, and provide the j^{th} second shift signal as a second scan signal for output in a black-insertion sub-period of the scan period to respectively drive the first and second pixel rows. The data-input sub-period and the black-insertion sub-period are non-overlapped.

According to a second aspect of the present invention, a gate driver applied to a liquid crystal display panel is provided. The gate driver is for driving k pixel rows of the liquid crystal display panel, wherein k is a natural number greater than 1. The gate driver includes a shift register circuit and an output logic circuit. The shift register circuit outputs an i^{th} first shift signal and a j^{th} second shift signal in a scan period according to a multiple-level startup signal. The i^{th} first shift signal and the j^{th} second shift signal respectively correspond to the first and second pixel rows of the k pixel rows, wherein i and j are natural numbers smaller than or equal to k. The output logic circuit is coupled to the shift register circuit and controlled by the first and second output enable signals to provide the i^{th} first shift signal as a first scan signal for output in a data-input sub-period of the scan period, and provide the j^{th} second shift signal as a second scan signal for output in a black-insertion sub-period of the scan period to respectively drive the first and second pixel rows. The data-input sub-period and the black-insertion sub-period are non-overlapped.

According to a third aspect of the present invention, a gate driver applied to a liquid crystal display panel is provided. The gate driver is for driving k pixel rows of the display panel, wherein k is a natural number greater than 1. The gate driver includes a shift register circuit and an output logic circuit. The shift register circuit outputs an i^{th} first shift signal and a j^{th} second shift signal in a scan period according to a first startup signal and a second startup signal. The i^{th} first shift signal and the j^{th} second shift signal respectively correspond to a first pixel row and a second pixel row of the k pixel rows, wherein i and j are natural numbers smaller than or equal to k. The output logic circuit is coupled to the shift register circuit and controlled by a multiple-level output enable signal to provide the i^{th} first shift signal as a first scan signal for output in a data-input sub-period of the scan period, and provide the j^{th} second shift signal as a second scan signal for output in a black-insertion sub-period of the scan period to respectively drive the first and second pixel rows. The data-input sub-period and the black-insertion sub-period are non-overlapped.

According to a fourth aspect of the present invention, a gate driver applied to a liquid crystal display panel is provided. The gate driver is for driving k pixel rows of the display panel, wherein k is a natural number greater than 1. The gate driver includes a shift register circuit and an output logic circuit. The shift register circuit outputs an i^{th} first shift signal and a j^{th} second shift signal in a scan period according to a multiple-level startup signal. The i^{th} first shift signal and the j^{th} second shift signal respectively correspond to the first and second pixel rows of the k pixel rows, wherein i and j are natural number smaller than or equal to k. The output logic circuit is coupled to the shift register circuit and controlled by a multiple-level output enable signal to provide the i^{th} first shift signal as a first scan signal for output in a data-input sub-period of the scan period and provide the j^{th} second shift signal as a second scan signal for output in a black-insertion sub-period of the scan period to respectively drive the first and second pixel rows. The data-input sub-period and the black-insertion sub-period are non-overlapped.

According to a fifth aspect of the present invention, a display driver applied to a liquid crystal display panel is provided. The display driver is for driving k pixel rows of the display panel, wherein k is a natural number greater than 1. The display driver includes a timing controller and a gate driver. The timing controller provides a multiple-level startup signal and a multiple-level output enable signal. The gate driver includes a shift register circuit and an output logic circuit. The shift register circuit outputs an i^{th} first shift signal and a j^{th} second shift signal in a scan period according to the multiple-level startup signal. The i^{th} first shift signal and the j^{th} second shift signal respectively correspond to the first and second pixel rows of the k pixel rows, wherein i and j are natural numbers smaller than or equal to k. The output logic circuit is coupled to the shift register circuit and controlled by the multiple-level output enable signal to provide the i^{th} first shift signal as a first scan signal for output in a data-input sub-period of the scan period, and provide the j^{th} second shift signal as a second scan signal for output in a black-insertion sub-period of the scan period to respectively drive the first and second pixel rows. The data-input sub-period and the black-insertion sub-period are non-overlapped.

The invention will become apparent from the following detailed description of the preferred but non-limiting embodiments. The following description is made with reference to the accompanying drawings.

### BRIEF DESCRIPTION OF THE DRAWINGS

FIG. 1 is a block diagram showing a display using a display driver according to an embodiment of the invention.

FIG. 2 is a block diagram showing a gate driver according to the embodiment of the invention.

FIG. 3 is a detailed block diagram showing a shift register circuit 12 of FIG. 2.

FIG. 4 is a timing chart showing associated signals of the shift register circuit 12 of FIG. 3.

FIG. 5 is a detailed circuit diagram showing a signal decomposing circuit 12a of FIG. 3.

FIG. 6 is a detailed circuit diagram showing a signal synthesis circuit 12d of FIG. 3.

FIG. 7 is a timing chart showing associated signals of the signal synthesis circuit 12d of FIG. 6.

FIG. 8 is a detailed block diagram showing an output logic circuit 14 of FIG. 2.

FIG. 9 is a timing chart showing associated signals of the output logic circuit of FIG. 8.

FIG. 10 is a detailed circuit diagram showing a signal decomposing circuit 14a of FIG. 8.

FIG. 11A is a block diagram showing a display using another display driver according to the embodiment of the invention.

FIG. 11B is a detailed block diagram showing the gate driver 1′ of FIG. 11A.

FIG. 12A is a block diagram showing a display using still another display driver according to the embodiment of the invention.

FIG. 12B is detailed block diagram showing the gate driver 1″ of FIG. 12A.

FIG. 13A is a block diagram showing a display using yet still another display driver according to the embodiment of the invention.

FIG. 13B is a detailed block diagram showing the gate driver 1′″ of FIG. 13A.

### DETAILED DESCRIPTION OF THE INVENTION

The gate driver of this embodiment provides a first set scan signal for controlling writing of normal image data and a second set scan signal for controlling insertion of black image data in response to a multiple-level startup signal and a multiple-level output enable signal.

The gate driver of this embodiment is applied to a display panel to drive k pixel rows of the display panel, wherein k is a natural number greater than 1. The gate driver includes a shift register circuit and an output logic circuit. The shift register circuit generates an i^{th} first shift signal and a j^{th} second shift signal in a scan period in response to the enabled multiple-level startup signal. The i^{th} first shift signal and the j^{th} second shift signal respectively correspond to a first pixel row and a second pixel row of the k pixel rows, wherein i and j are natural numbers smaller than or equal to k.

The output logic circuit is controlled by the multiple-level output enable signal to provide the i^{th} first shift signal as a first scan signal for output and the j^{th} second shift signal as a second scan signal for output in a data-input sub-period and a black-insertion sub-period of the scan period, respectively, to respectively drive the first and the second pixel rows such that the normal data and the black insertion data may be written. The data-input sub-period and the black-insertion sub-period are non-overlapped.

The shift register circuit receives, without limitation to, the multiple-level startup signal, and may further receive two startup signals to perform the similar operations. The output logic circuit receives, without limitation to, the multiple-level output enable signal, and may further receive two output enable signals to perform the similar operations. Examples will be illustrated in the following to further describe the shift register circuit of this embodiment.

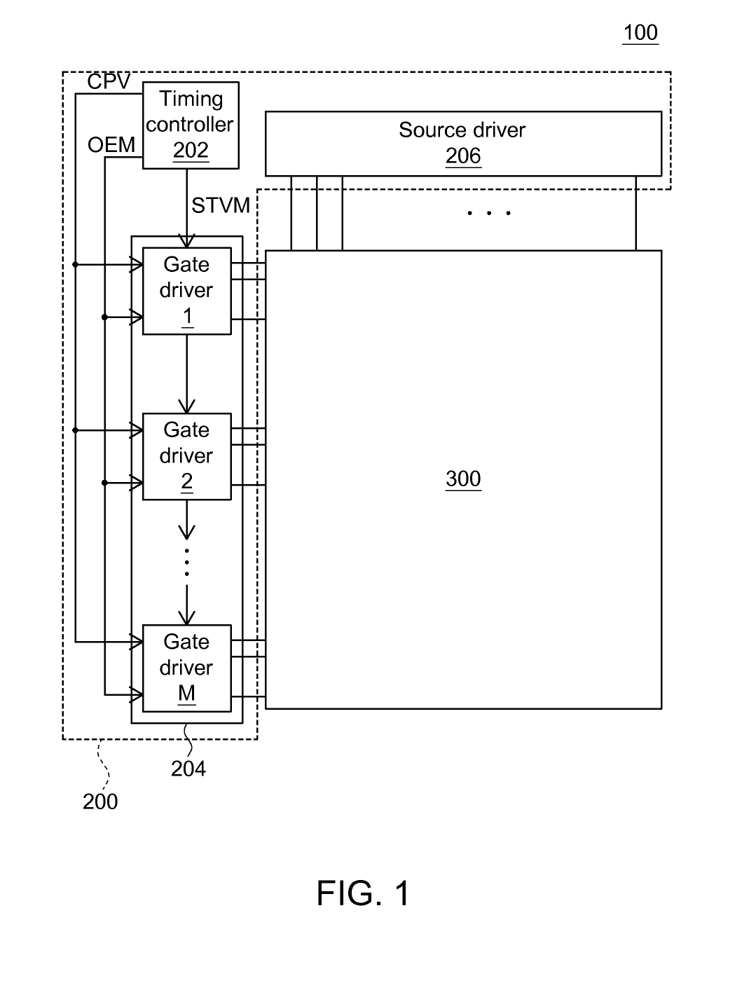

FIG. 1 is a block diagram showing a display 100 using a display driver according to an embodiment of the invention. Referring to FIG. 1, the display 100 includes a display driver 200 and a display panel 300. The display panel 300 includes m pixel rows, wherein m is a natural number greater than 1. The display driver 200 includes a timing controller 202 and a gate driving circuit 204. The timing controller 202 provides a clock signal CPV, a multiple-level output enable signal OEM and a multiple-level startup signal STVMO to the gate driving circuit 204 to drive it to provide m scan signals for respectively driving the m pixel rows of the display panel 300.

The gate driving circuit 204 includes multiple gate drivers 1 to M, each of which drives a portion of the pixel rows of the m pixel rows, wherein M is a natural number greater than 1. The operations of the gate drivers 1 to M are substantially similar to each other, and the operation of the gate driver 1 will be illustrated as an example. The gate driver 1 drives, for example, the former k pixel rows of the display panel 300, wherein k is a natural number smaller than or equal to m.

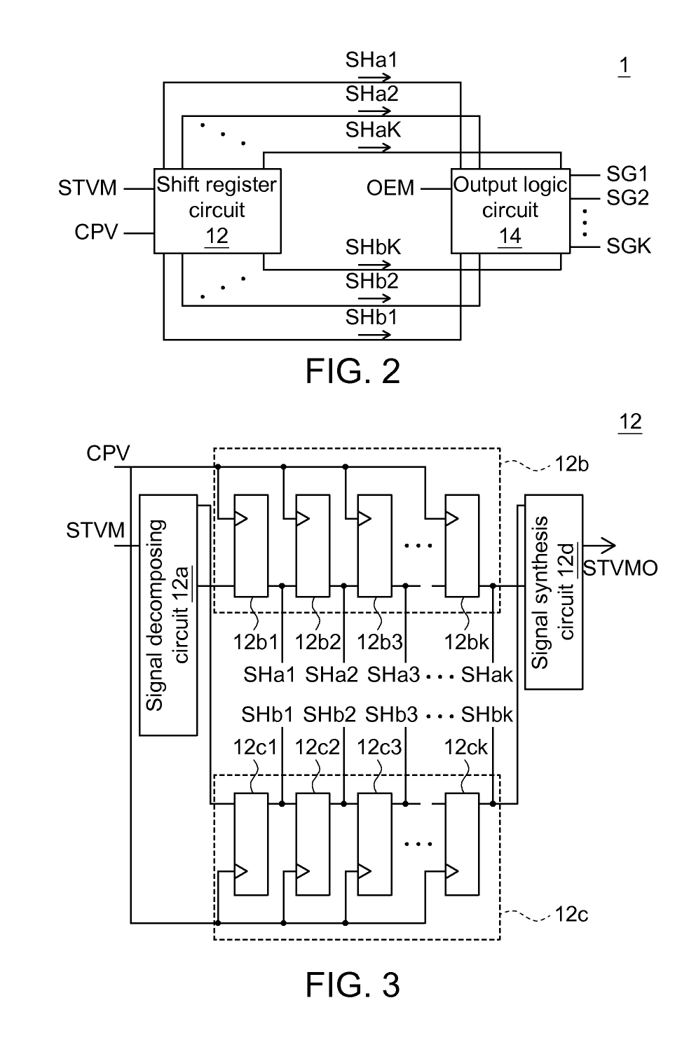

FIG. 2 is a block diagram showing the gate driver 1 according to the embodiment of the invention. Referring to FIG. 2, the gate driver 1 includes a shift register circuit 12 and an output logic circuit 14. The shift register circuit 12 generates k first shift signals SHa1 to SHak and k second shift signals SHb1 to SHbk in response to the enabled multiple-level startup signal STVM.

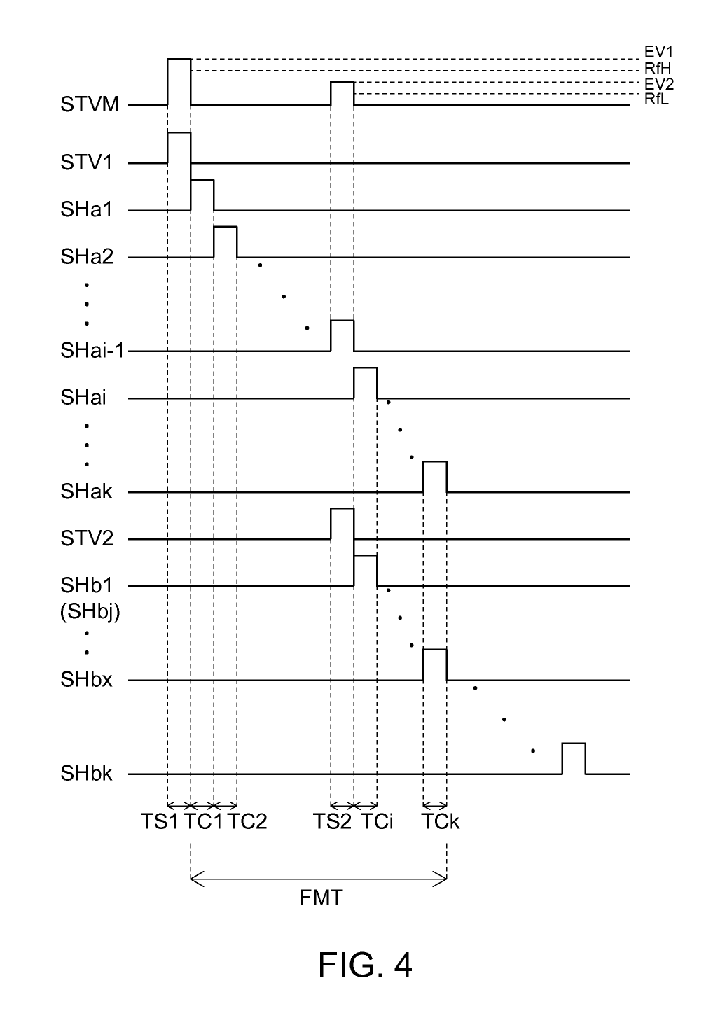

FIG. 3 is a detailed block diagram showing the shift register circuit 12 of FIG. 2. FIG. 4 is a timing chart showing associated signals of the shift register circuit 12 of FIG. 3. Referring to FIGS. 3 and 4, the shift register circuit 12 includes a signal decomposing circuit 12a, shift register units 12b and 12c and a signal synthesis circuit 12d. The signal decomposing circuit 12a receives a first enable level of the multiple-level startup signal STVMO and generates an enabled startup signal STV1, and generates an enabled startup signal STV2 in response to a second enable level of the multiple-level startup signal STVM. For example, the startup signal STVMO has a level EV1 (first enable level) in a period TS1, and has a level EV2 (second enable level) in a period TS2. The signal decomposing circuit 12a correspondingly enables the startup signals STV1 and STV2 in the periods TS1 and TS2.

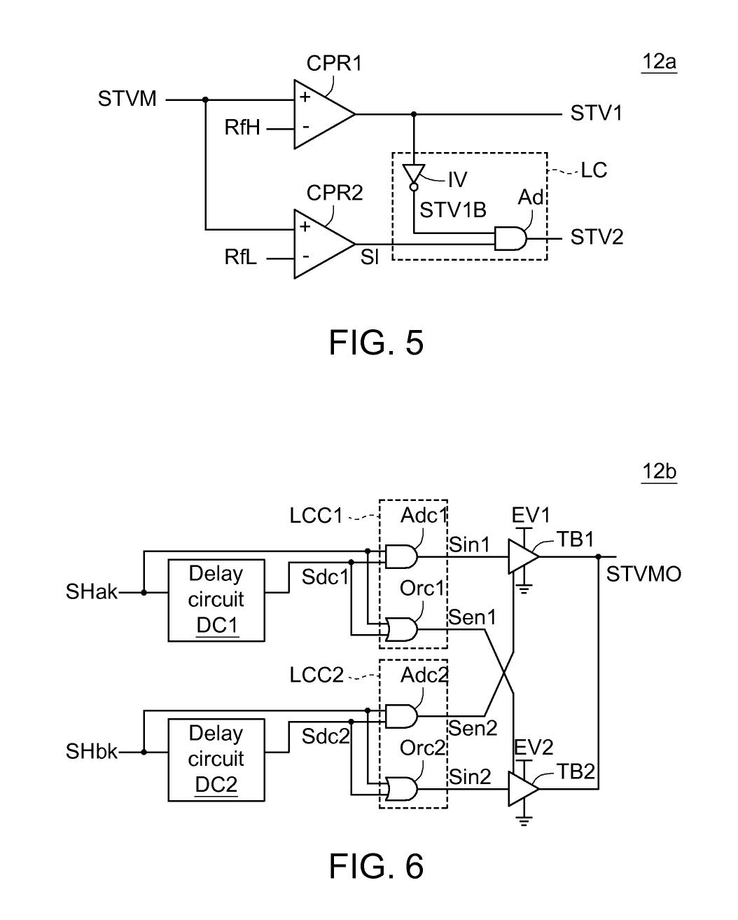

FIG. 5 is a detailed circuit diagram showing the signal decomposing circuit 12a of FIG. 3 in one example. Referring to FIG. 5, the signal decomposing circuit 12a includes comparators CPR1 and CPR2 and a logic circuit LC. A positive input terminal and a negative input terminal of the comparator CPR1 respectively receive the multiple-level startup signal STVMO and a high level reference voltage RfH. The level of the high level reference voltage RfH ranges between the levels EV1 and EV2, for example. The comparator CPR1 provides the enabled startup signal STV1 when the level of the multiple-level startup signal STVMO is higher than the high level reference voltage RfH.

The positive input terminal and the negative input terminal of the comparator CPR2 respectively receive the multiple-level startup signal STVMO and a low level reference voltage RfL. The level of the low level reference voltage RfL is lower than the level EV2, for example. The comparator CPR2 provides an enabled logic signal SI when the level of the multiple-level startup signal STVMO is higher than the low level reference voltage RfL.

The logic circuit LC performs a logic multiplication (And) operation on an inversion signal STV1B of the startup signal STV1 and the logic signal SI to obtain the startup signal STV2. For example, the logic circuit LC includes a phase inverter IV and an AND gate Ad.

The shift register unit 12b includes k stage circuits 12b1 to 12bk, each of the stage circuits 12b1 to 12bk may be implemented by a flip-flop. The shift register unit 12b is controlled by the startup signal STV1 to generate the first shift signals SHa1 to SHak respectively corresponding to k pixel rows of the display panel. Enable periods of the first shift signals SHa1 to SHak respectively define scan periods TC1 to TCk. The period containing the scan periods TC1 to TCk is defined as a frame period FMT. In the corresponding scan periods TC1 to TCk, the first shift signals SHa1 to SHak are respectively enabled to drive k rows of pixels of the display panel such that the corresponding pixel data may be written into the rows of pixels.

The shift register unit 12c includes k stage circuits 12c1 to 12ck, each of which may be implemented by a flip-flop. The shift register unit 12c is controlled by the startup signal STV2 to generate the second shift signals SHb1 to SHbk respectively corresponding to the k pixel rows of the display panel. In one example, the enable period TS2 of the startup signal STV2 corresponds to the scan period TCi−1, for example. Thus, the enable period of the second shift signal SHb1 corresponds to the scan period TCi. In other words, the scan signals SHai and SHb1 are enabled in the same scan period TCi. Similarly, the second shift signals SHb2 to SHbx and the first shift signals SHai+1 to SHak are respectively enabled in the same scan periods TCi+1 to TCk.

The signal synthesis circuit 12d receives the first shift signal SHak and the second shift signal SHbk and thus synthesizes them to obtain an output multiple-level startup signal STVMO. In one example, the output multiple-level startup signal STVMO is provided to the next gate driver 2 to drive it to provide the corresponding scan signal.

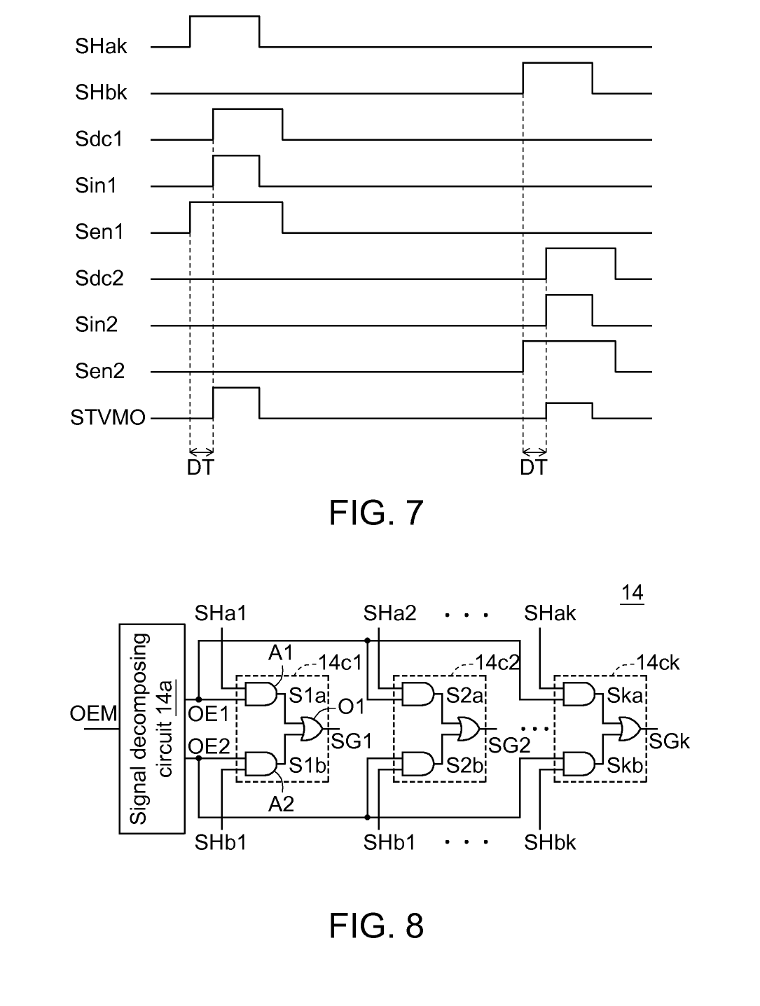

FIGS. 6 and 7 are respectively a detailed circuit diagram and a timing chart showing the signal synthesis circuit 12d of FIG. 3. Referring to FIGS. 6 and 7, the signal synthesis circuit 12d includes delay circuits DC1 and DC2, logic circuits LCC1 and LCC2 and tri-state buffers TB1 and TB2. The delay circuits DC1 and DC2 respectively delay the k^{th} first shift signal SHak and the k^{th} second shift signal SHbk by a delay time DT to respectively provide delay signals Sdc1 and Sdc2.

The logic circuit LCC1 provides an enabled internal signal Sin1 when the delay signal Sdc1 and the k^{th} first shift signal SHak are enabled, and provides an enabled enable signal Sen2 when any one of the delay signal Sdc1 and the k^{th} first shift signal SHak is enabled. In one example, the logic circuit LCC1 includes an AND gate Adc1 and an OR gate Orc1. The corresponding logic multiplication operation and logic summation operation are performed through the AND gate Adc1 and the OR gate Orc1 to respectively obtain the internal signal Sin1 and the enable signal Sen1.

Similarly, the logic circuit LCC2 provides the enabled internal signal Sin2 when the delay signal Sdc2 and the k^{th} second shift signal SHbk are enabled, and provides the enabled enable signal Sen2 when any one of the delay signal SHbk and the k^{th} second shift signal SHbk is enabled. In one example, the logic circuit LCC2 has an AND gate Adc2 and an OR gate Orc2 to perform the operation similar to that of the logic circuit LCC1.

The tri-state buffer TB1 provides the output multiple-level startup signal STVMO having the level EV1 according to the enabled internal signal Sin1 in response to the enabled enable signal Sen2. When the enable signal Sen2 is disabled, the tri-state buffer TB1 is in the high impedance state.

The tri-state buffer TB2 provides the output multiple-level startup signal STVMO having the level EV2 according to the enabled internal signal Sin2 in response to the enabled enable signal Sen1. When the enable signal Sen1 is disabled, the tri-state buffer TB2 is in the high impedance state.

The output logic circuit 14 is controlled by the multiple-level output enable signal OEM to provide the correspondingly enabled first shift signal as the enabled first scan signal for output, and to provide the correspondingly enabled second shift signal as the enabled second scan signal for output in the data-input sub-period and the black-insertion sub-period of each of the scan periods TC1 to TCk. Because the output logic circuit 14 performs similar operations in the scan periods TC1 to TCk, only the operation performed by the output logic circuit 14 in the scan period TCi is described as an example.

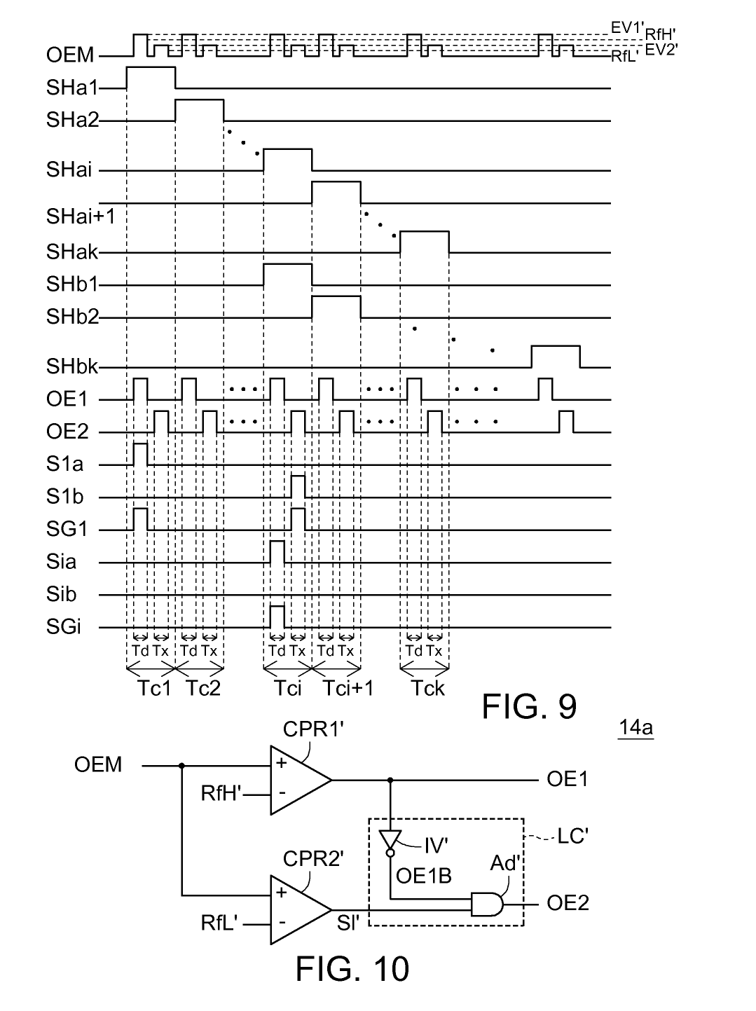

FIG. 8 is a detailed block diagram showing the output logic circuit 14 of FIG. 2. FIG. 9 is a timing chart showing associated signals of the output logic circuit of FIG. 8. Referring to FIGS. 8 and 9, the output logic circuit 14 includes a signal decomposing circuit 14a and k output logic units 14c1 to 14ck. The signal decomposing circuit 14a provides output enable signals OE1 and OE2 according to the multiple-level output enable signal OEM to define a data input period Td and a black-insertion sub-period Tx.

For example, the enable signal OE1 is enabled in the data input period Td of each of the scan periods TC1 to TCk. The enable signal OE2 is enabled in the black-insertion sub-period Tx of each of the scan periods TC1 to TCk.

FIG. 10 is a detailed circuit diagram showing the signal decomposing circuit 14a of FIG. 8. In one example, as shown in FIG. 10, the signal decomposing circuit 14a and the signal decomposing circuit 12a of the shift register circuit 12 have similar circuit structures and operations. Herein, the detailed operation of the signal decomposing circuit 14a will be omitted.

According to FIG. 8, it is obtained that the output logic units 14c1 to 14ck have similar circuit structures and operations. For example, the output logic unit 14c1 includes AND gates A1 and A2 and an OR gate O1. Two input terminals of the AND gate A1 respectively receive the first shift signal SHa1 and the output enable signal OE1 to perform the corresponding logic multiplication operation to obtain the signal S1a. Two input terminals of the AND gate A2 respectively receive the second shift signal SHb1 and the output enable signal OE2 to perform the corresponding logic multiplication operation to obtain the signal S1b. The OR gate O1 performs the logic operation on the signals S1a and S1b to obtain the scan signal SG1. Similarly, the other output logic units 14c2 to 14ck also generate the corresponding signals S2a to Ska and S2b to Skb according to the corresponding first and second shift signals.

In one practical example, the shift signals SHai and SHb1 are enabled in the scan period TCi. Only the signal Sia among the signals S1a to Ska is enabled in the data writing period Td of the scan period TCi. Thus, the output logic unit 14ci correspondingly provides the enabled scan signal SGi to turn on the i^{th} pixel row of the k pixel rows to write the normal image data in the data writing period Td of the scan period TCi.

Similarly, only the signal S1b among the signals S2a to Ska is enabled in the black-insertion sub-period Tx of the scan period TCi. Thus, in the black-insertion sub-period Tx of the scan period TCi, the output logic unit 14c1 correspondingly provides the enabled scan signal SG1 to turn on the first pixel row of the k pixel rows to write the black image data.

In another practical example, the shift signal SHa1 in the scan period TC1 is enabled. Thus, only the signal S1a among the signals S1a to Ska is enabled in the data writing period Td of the scan period TC1. Thus, the output logic unit 14c1 correspondingly provides the enabled scan signal Sg1 to turn on the first pixel row of the k pixel rows to write the normal image data in the data writing period Td of the scan period TC1.

In this practical example, the shift signals SHb1 to SHbk are not enabled in the scan period TC1. Thus, all the scan signals SG1 to SGk are not enabled in the black-insertion sub-period Tx of the scan period TC1. In other words, no black frame data is written at this time.

According to the operations in the scan periods TC1 and TC1, the operations of the output logic units 141 to 14k in other scan periods TC1 to TCk of the frame period FMT may be obtained analogically. Herein, detailed descriptions will be omitted.

According to the contents mentioned hereinabove, the ratio of time of inserting the black frame data in the frame period FMT relates to the time, for which the multiple-level startup signal STVMO is increased to the level EV2. For example, the multiple-level startup signal STVMO is correspondingly increased to the level EV2 in the scan period TCi−1. In this example, no black pixel data is inserted in the scan period of the former i pixel rows of the k pixel rows because the shift signals SHb to SHbk are continuously disabled. In the later scan period of the (k−i+1) pixel rows of the k pixel rows, the black pixel data has been inserted.

Thus, the ratio of time of inserting the black frame data in the frame period FMT can be effectively adjusted by adjusting the time point when the multiple-level startup signal STVMO is lifted to the level EV2. Consequently, the display driver 200 of this embodiment may further have the advantage of flexibly adjusting the ratio of time of inserting the black frame data of the display frame.

In one example, the timing controller 202 also includes a signal synthesis circuit for synthesizing the startup signals STV1 and STV2 to generate the multiple-level startup signal STVM, and synthesizing the output enable signals OE1 and OE2 to generate the multiple-level output enable signal OEM.

In this embodiment, the display driver 200 further includes a source driver 206 for providing the normal image data and the black image data to the display panel 300 in the data writing period Td and the black-insertion sub-period Tx of each of the scan periods SC1 to SCk, respectively.

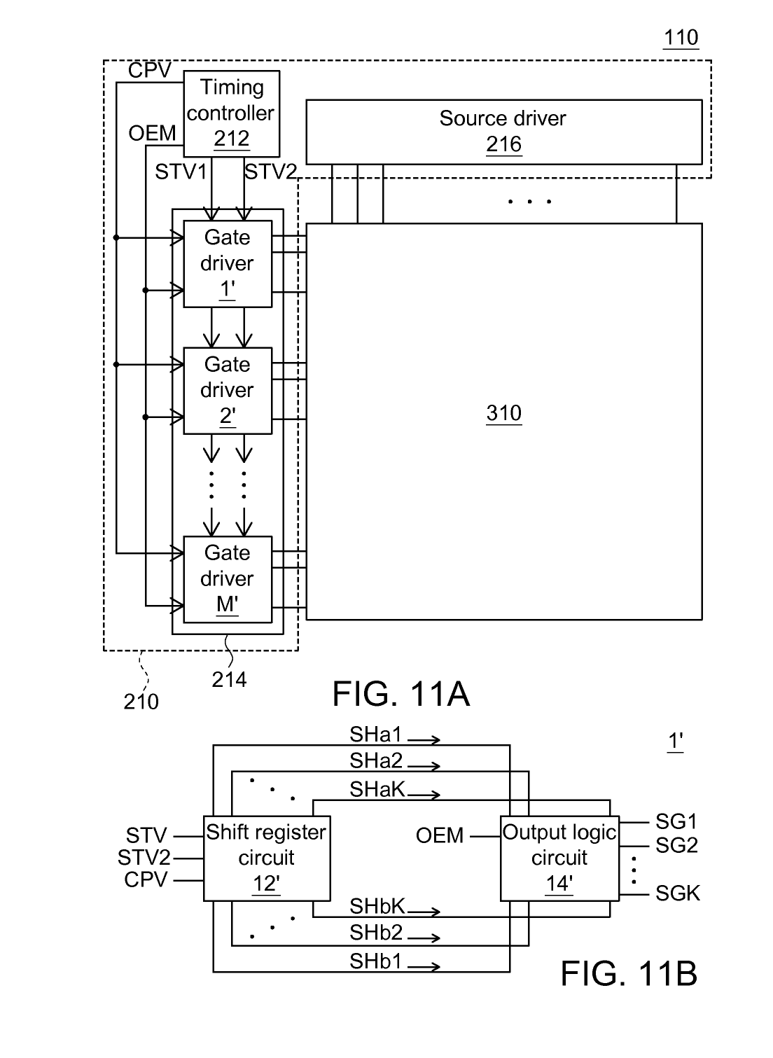

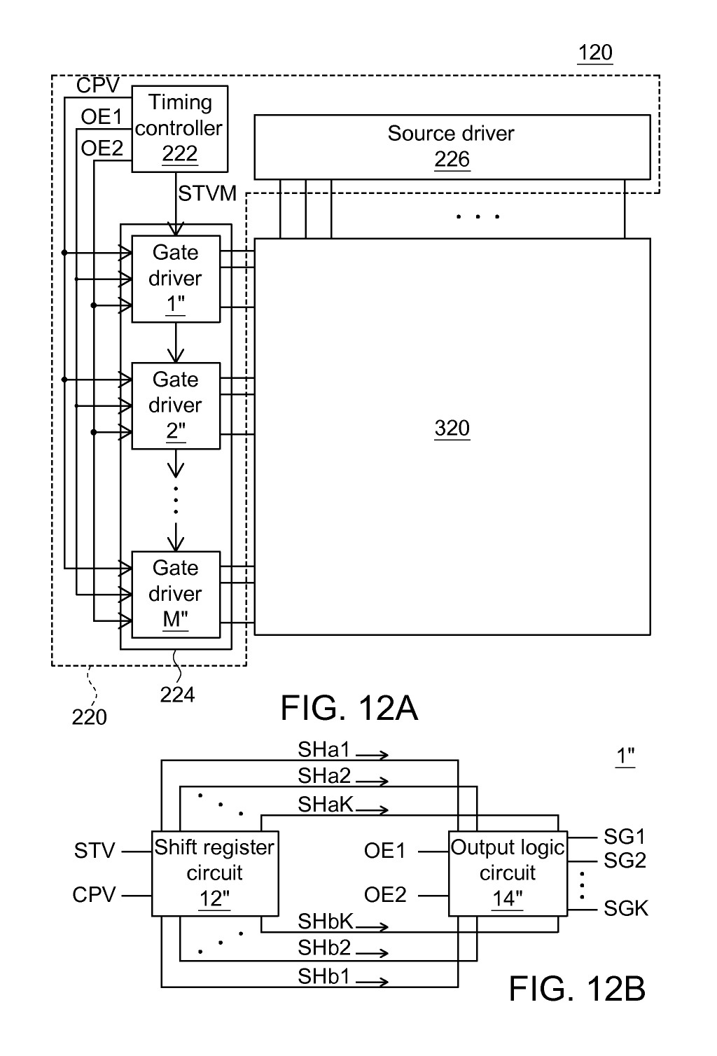

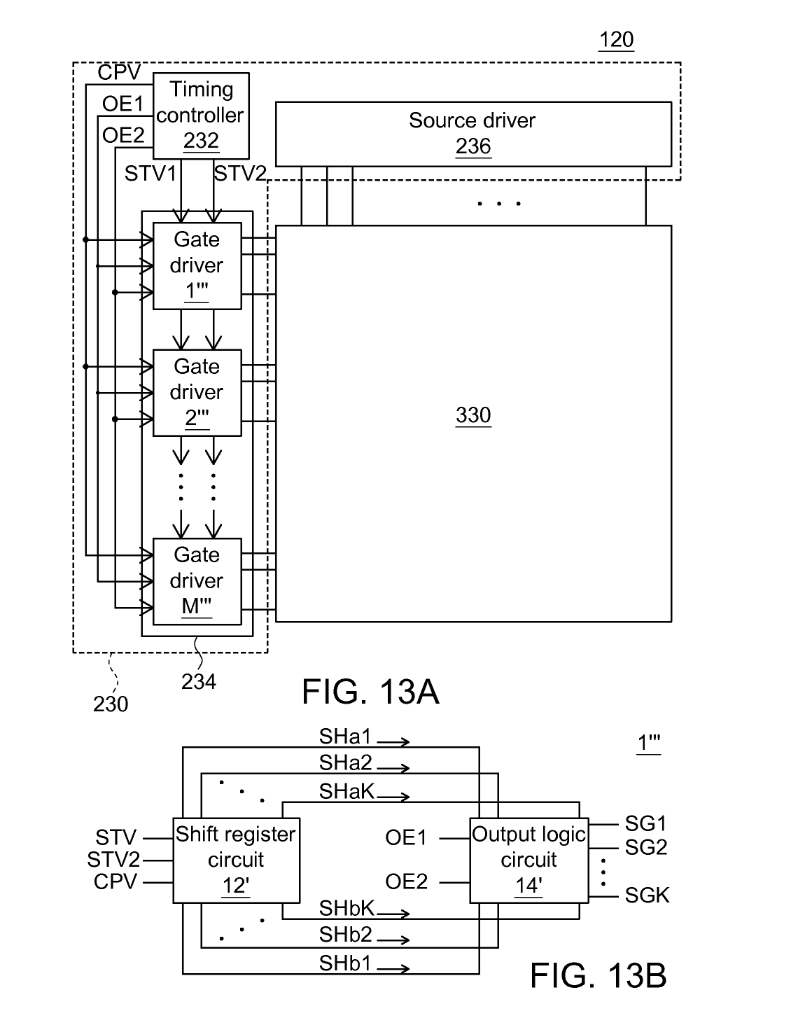

In this embodiment, only the condition that the timing controller 202 provides the multiple-level startup signal STVMO and the multiple-level output enable signal OEM to drive the gate drivers 1 to M of the gate driving circuit 204 is illustrated as an example. However, the display driver 200 of this embodiment is not limited thereto. In another example, the timing controller 212 provides the two startup signals STV1 and STV2 and the multiple-level output enable signal OEM to drive the gate drivers 1′ to M′, as shown in FIGS. 11A and 11B. In still another example, the timing controller 222 provides the multiple-level startup signal STVMO and the two output enable signals OE1 and OE2 to drive the gate drivers 1″ to M″, as shown in FIGS. 12A and 12B. In yet still another example, the timing controller 232 provides the two startup signals STV1 and STV2 and the two output enable signals OE1 and OE2 to drive the gate drivers 1′″ to M′″, as shown in FIGS. 13A and 13B.

In the example of FIGS. 11A and 11B, one signal synthesis circuit is omitted from the timing controller 212 and each of the gate drivers 1′ to M′, and the startup signal is directly transmitted in the form of two startup signals STV1 and STV2. In the example of FIGS. 12A and 12B, one signal synthesis circuit is omitted from the timing controller 222, and the output enable signal is transmitted directly in the form of two output enable signals OE1 and OE2. In the example of FIGS. 13A and 13B, two signal synthesis circuits may be omitted from the timing controller 232, and one signal synthesis circuit may also be omitted from each of the gate drivers 1′″ to M′″.

The gate driver according to the embodiment of the invention is controlled by the multiple-level startup signal and the multiple-level output enable signal to provide the first set scan signal for controlling the writing of the data and the second set scan signal for controlling the writing of the black insertion data. Compared with the conventional gate driver, the gate driver of the invention has the low cost and can flexibly adjust the insertion ratio of the black image data to solve the phenomenon of the motion residual image of the liquid crystal display.

In addition, the gate driver of this embodiment further can adjust the time, for which the multiple-level startup signal is increased to the second enable level, to advantageously and flexibly adjust the ratio of time of inserting the black frame data of the display frame in the specific frame period.

Furthermore, the display driver of this embodiment controls the gate driver according to, without limitation to, the multiple-level startup signal and the multiple-level output enable signal. However, the display driver of this embodiment may further control the gate driver more flexibly according to two startup signals with one single enable level or in response to two output enable signals with one single enable level. In these examples, the signal synthesis circuits may be partially or entirely omitted from the gate driver and the timing controller of the display driver such that the display driver of this embodiment further has the advantage of the lower cost.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A gate driver, applied to a display panel, for driving k pixel rows of the display panel, k being a natural number greater than 1, the gate driver comprising:
a shift register circuit for outputting an i^{th} first shift signal and a j^{th} second shift signal in a scan period according to a first startup signal and a second startup signal, wherein the i^{th} first shift signal and the j^{th} second shift signal respectively correspond to a first pixel row and a second pixel row in the k pixel rows, and i and j are natural numbers smaller than or equal to k; and
an output logic circuit, coupled to the shift register circuit and controlled by a first output enable signal and a second output enable signal to provide the i^{th} first shift signal as a first scan signal for output in a data-input sub-period of the scan period, and provide the j^{th} second shift signal as a second scan signal for output in a black-insertion sub-period of the scan period to respectively drive the first pixel row and the second pixel row,
wherein the data-input sub-period and the black-insertion sub-period are non-overlapped.

2. The gate driver according to claim 1, wherein the shift register circuit comprises:
a first shift register unit comprising k first stage circuits, connected in series, for generating k first shift signals according to the first startup signal; and
a second shift register unit comprising k second stage circuits, connected in series, for generating k second shift signals according to the second startup signal,
wherein i and j are natural numbers smaller than or equal to k.

3. The gate driver according to claim 2, wherein the output logic circuit comprises k output logic units respectively corresponding to the k pixel rows, and each of the k output logic units comprises:
a first logic gate for providing the corresponding first shift signal according to the first output enable signal, which is enabled;
a second logic gate for providing the corresponding second shift signal according to the second output enable signal; and
an output logic gate for performing a logic summation on the first and second shift signals, provided by the first and second logic gates, to generate the corresponding scan signal.

4. The gate driver according to claim 2, further comprising:
a signal decomposing circuit for receiving a multiple-level startup signal and decomposing the multiple-level startup signal into the first startup signal and the second startup signal according to a first enable level and a second enable level; and
a signal synthesis circuit for enabling an output multiple-level startup signal to have the first enable level according to the k^{th} first shift signal, and enabling the output multiple-level startup signal to have the second enable level according to the k^{th} second shift signal.

5. The gate driver according to claim 4, wherein the signal decomposing circuit comprises:
a first comparator for providing the first startup signal when a level of the multiple-level startup signal is higher than a high level reference voltage;
a second comparator for providing a logic signal when the level of the multiple-level startup signal is higher than a low level reference voltage; and
a logic circuit for performing a logic multiplication (And) operation on an inversion signal of the first startup signal and the logic signal to obtain the second startup signal.

6. The gate driver according to claim 4, wherein the signal synthesis circuit comprises:
a first delay circuit and a second delay circuit for respectively delaying the k^{th} first shift signal and the k^{th} second shift signal by a delay time and thus providing a first delay signal and a second delay signal;
a first set logic circuit for providing a first internal signal when the first delay signal and the k^{th} first shift signal are enabled, and providing a first enable signal when any one of the first delay signal and the k^{th} first shift signal is enabled;
a second set logic circuit for providing a second internal signal when the second delay signal and the k^{th} second shift signal are enabled, and providing a second enable signal when any one of the second delay signal and the k^{th} second shift signal is enabled;
a first tri-state buffer for enabling the multiple-level startup signal to have the first enable level according to the first internal signal when the second enable signal is enabled; and
a second tri-state buffer for enabling the multiple-level startup signal to have the second enable level according to the second internal signal when the first enable signal is enabled.

7. The gate driver according to claim 1, further comprising:
a signal decomposing circuit for generating the first output enable signal according to a first enable level of a multiple-level output enable signal, and generating the second output enable signal according to a second enable level of the multiple-level output enable signal.

8. The gate driver according to claim 7, wherein the signal decomposing circuit comprises:
a first comparator for providing the first output enable signal when a level of the multiple-level output enable signal is higher than a high level reference voltage;
a second comparator for providing a logic signal when the level of the multiple-level output enable signal is higher than a low level reference voltage; and
a logic circuit for performing a logic multiplication (And) operation on an inversion signal of the first output enable signal and the logic signal to obtain the second output enable signal.

9. A gate driver, applied to a display panel, for driving k pixel rows of the display panel, k being a natural number greater than 1, the gate driver comprising:
a shift register circuit for outputting an i^{th} first shift signal and a j^{th} second shift signal in a scan period according to a multiple-level startup signal, wherein the i^{th} first shift signal and the j^{th} second shift signal respectively correspond to a first pixel row and a second pixel row of the k pixel rows, and i and j are natural numbers smaller than or equal to k; and
an output logic circuit coupled to the shift register circuit and controlled by a first output enable signal and a second output enable signal to provide the i^{th} first shift signal as a first scan signal for output in a data-input sub-period of the scan period and to provide the j^{th} second shift signal as a second scan signal for output in a black-insertion sub-period of the scan period to respectively drive the first pixel row and the second pixel row,
wherein the data-input sub-period and the black-insertion sub-period are non-overlapped.

10. The gate driver according to claim 9, wherein the shift register circuit comprises:
a signal decomposing circuit for receiving the multiple-level startup signal and decomposing the multiple-level startup signal into a first startup signal and a second startup signal according to a first enable level and a second enable level;
a first shift register unit comprising k first stage circuits, connected in series, for generating k first shift signals according to the first startup signal;
a second shift register unit comprising k second stage circuits, connected in series, for generating k second shift signals according to the second startup signal; and
a signal synthesis circuit for enabling an output multiple-level startup signal to have the first enable level according to the k^{th} first shift signal, and enabling the output multiple-level startup signal to have the second enable level according to the k^{th} second shift signal,
wherein i and j are natural numbers smaller than or equal to k.

11. The gate driver according to claim 10, wherein the output logic circuit comprises k output logic units respectively corresponding to the k pixel rows, and each of the k output logic units comprises:
a first logic gate for receiving the corresponding first shift signal and the first output enable signal and providing the corresponding first shift signal according to the first output enable signal;
a second logic gate for receiving the corresponding second shift signal and the second output enable signal and providing the corresponding second shift signal according to the second output enable signal; and
an output logic gate for performing a logic summation on the first and second shift signals, provided by the first and second logic gates, to generate the corresponding scan signal.

12. The gate driver according to claim 9, further comprising:
a signal decomposing circuit for receiving a multiple-level output enable signal and decomposing the multiple-level startup signal into the first output enable signal and the second output enable signal according to a first enable level.

13. A gate driver, applied to a display panel, for driving k pixel rows of the display panel, k being a natural number greater than 1, the gate driver comprising:
a shift register circuit for outputting an i^{th} first shift signal and a j^{th} second shift signal in a scan period according to a first startup signal and a second startup signal, wherein the i^{th} first shift signal and the j^{th} second shift signal respectively correspond to a first pixel row and a second pixel row in the k pixel rows, and i and j are natural numbers smaller than or equal to k; and
an output logic circuit coupled to the shift register circuit and controlled by a multiple-level output enable signal to provide the i^{th} first shift signal as a first scan signal for output in a data-input sub-period of the scan period, and provide the j^{th} second shift signal as a second scan signal for output in a black-insertion sub-period of the scan period to respectively drive the first pixel row and the second pixel row,
wherein the data-input sub-period and the black-insertion sub-period are non-overlapped.

14. The gate driver according to claim 13, wherein the shift register circuit comprises:
a first shift register unit comprising k first stage circuits, connected in series, for generating k first shift signals according to the first startup signal; and
a second shift register unit comprising k second stage circuits, connected in series, for generating k second shift signals according to the second startup signal,
wherein i and j are natural numbers smaller than or equal to k.

15. The gate driver according to claim 14, wherein the output logic circuit comprises:
a signal decomposing circuit for receiving a first enable level of the multiple-level output enable signal to generate a first output enable signal, and generating a second output enable signal according to a second enable level of the multiple-level output enable signal; and
k output logic units respectively corresponding to the k pixel rows, each of the k output logic units comprising:
a first logic gate for receiving the corresponding first shift signal and the first output enable signal and providing the corresponding first shift signal according to the first output enable signal;
a second logic gate for receiving the corresponding second shift signal and the second output enable signal and providing the corresponding second shift signal according to the second output enable signal, which is enabled; and
an output logic gate for performing a logic summation on the first and second shift signals, provided by the first and second logic gates, to generate the corresponding scan signal.

16. The gate driver according to claim 13, further comprising:
a signal decomposing circuit for receiving a multiple-level startup signal and decomposing the multiple-level startup signal into the first startup signal and the second startup signal according to a first enable level and a second enable level; and
a signal synthesis circuit for enabling an output multiple-level startup signal to have the first enable level according to the k^{th} first shift signal, and enabling the output multiple-level startup signal to have the second enable level according to the k^{th} second shift signal.

17. A gate driver, applied to a display panel, for driving k pixel rows of the display panel, k being a natural number greater than 1, the gate driver comprising:
a shift register circuit for outputting an i^{th} first shift signal and a j^{th} second shift signal in a scan period according to a multiple-level startup signal, wherein the i^{th} first shift signal and the j^{th} second shift signal respectively correspond to a first pixel row and a second pixel row of the k pixel rows, and i and j are natural numbers smaller than or equal to k; and
an output logic circuit coupled to the shift register circuit and controlled by a multiple-level output enable signal to provide the i^{th} first shift signal as a first scan signal for output in a data-input sub-period of the scan period, and provide the j^{th} second shift signal as a second scan signal for output in a black-insertion sub-period of the scan period to respectively drive the first pixel row and the second pixel row,
wherein the data-input sub-period and the black-insertion sub-period are non-overlapped.

18. The gate driver according to claim 17, wherein the shift register circuit comprises:
a first signal decomposing circuit for receiving the multiple-level startup signal, and decomposing the multiple-level startup signal into a first startup signal and a second startup signal according to a first enable level and a second enable level;
a first shift register unit comprising k first stage circuits, connected in series, for generating k first shift signals according to the first startup signal;
a second shift register unit comprising k second stage circuits, connected in series, for generating k second shift signals according to the second startup signal; and
a first signal synthesis circuit for enabling an output multiple-level startup signal to have the first enable level according to the k^{th} first shift signal and enabling the output multiple-level startup signal to have the second enable level according to the k^{th} second shift signal,
wherein i and j are natural numbers smaller than or equal to k.

19. The gate driver according to claim 18, wherein the output logic circuit comprises:
a second signal decomposing circuit for generating a first output enable signal according to the first enable level of the multiple-level output enable signal and generating a second output enable signal according to the second enable level of the multiple-level output enable signal; and
k output logic units respectively corresponding to the k pixel rows, each of the k output logic units comprising:
a first logic gate for receiving the corresponding first shift signal and the first output enable signal and providing the corresponding first shift signal according to the first output enable signal;
a second logic gate for receiving the corresponding second shift signal and the second output enable signal and providing the corresponding second shift signal according to the second output enable signal, which is enabled;
an output logic gate for performing a logic summation (And) operation on the first and second shift signals, provided by the first and second logic gates, to generate the corresponding scan signal.

20. A display driver, applied to a display panel, for driving k pixel rows of the display panel, wherein k is a natural number greater than 1, the display driver comprising:
a timing controller for providing a multiple-level startup signal and a multiple-level output enable signal; and
a gate driver, comprising:
a shift register circuit for outputting an i^{th} first shift signal and a j^{th} second shift signal in a scan period according to the multiple-level startup signal, wherein the i^{th} first shift signal and the j^{th} second shift signal respectively correspond to a first pixel row and a second pixel row of the k pixel rows, and i and j are natural numbers smaller than or equal to k; and
an output logic circuit coupled to the shift register circuit and controlled by a first enable level of the multiple-level output enable signal to provide the i^{th} first shift signal as a first scan signal for output in a data-input sub-period of the scan period, and controlled by a second enable level of the multiple-level output enable signal to provide the j^{th} second shift signal as a second scan signal for output in a back-insertion sub-period of the scan period to respectively drive the first and second pixel rows,
wherein the data-input sub-period and the black-insertion sub-period are non-overlapped.

21. The display driver according to claim 20, wherein the shift register circuit comprises:
a first signal decomposing circuit for receiving the multiple-level startup signal and decomposing the multiple-level startup signal into a first startup signal and a second startup signal according to a first enable level and a second enable level;
a first shift register unit comprising k first stage circuits, connected in series, for generating k first shift signals according to the first startup signal, which is enabled;
a second shift register unit comprising k second stage circuits, connected in series, for generating k second shift signals according to the second startup signal, which is enabled; and
a first signal synthesis circuit for enabling an output multiple-level startup signal to have the first enable level according to the k^{th} first shift signal and enabling the output multiple-level startup signal to have the second enable level according to the k^{th} second shift signal.

22. The display driver according to claim 21, wherein the output logic circuit comprises:
a second signal decomposing circuit for generating a first output enable signal according to the first enable level of the multiple-level output enable signal, and generating a second output enable signal according to the second enable level of the multiple-level output enable signal;
k output logic units respectively corresponding to the k pixel rows, each of the k output logic units comprising:
a first logic gate for receiving the corresponding first shift signal and the first output enable signal and providing the corresponding first shift signal according to the first output enable signal;
a second logic gate for receiving the corresponding second shift signal and the second output enable signal, and providing the corresponding second shift signal according to the second output enable signal; and
an output logic gate for performing a logic summation on the first and second shift signals, provided by the first and second logic gates, to generate the corresponding scan signal.

23. The display driver according to claim 22, wherein the second signal decomposing circuit comprises:
a first comparator for providing the first output enable signal when a level of the multiple-level output enable signal is higher than a high level reference voltage;
a second comparator for providing a logic signal when the level of the multiple-level output enable signal is higher than a low level reference voltage; and
a logic circuit for performing a logic multiplication (And) operation on an inversion signal of the first startup signal and the logic signal to obtain the second output enable signal.

24. The display driver according to claim 21, wherein the first signal decomposing circuit comprises:
a first comparator for providing the first startup signal when a level of the multiple-level startup signal is higher than a high level reference voltage;
a second comparator for providing a logic signal when the level of the multiple-level startup signal is higher than a low level reference voltage; and
a logic circuit for performing a logic multiplication operation on an inversion signal of the first startup signal and the logic signal to obtain the second startup signal.

25. The display driver according to claim 21, wherein the first signal synthesis circuit comprises:
a first delay circuit and a second delay circuit for delaying the k^{th} first shift signal and the k^{th} second shift signal by a delay time to provide a first delay signal and a second delay signal, respectively;
a first set logic circuit for providing a first internal signal when the first delay signal and the k^{th} first shift signal are enabled, and providing a first enable signal when any one of the first delay signal and the k^{th} first shift signal is enabled;
a second set logic circuit for providing a second internal signal when the second delay signal and the k^{th} second shift signal are enabled, and providing a second enable signal when any one of the second delay signal and the k^{th} second shift signal is enabled;
a first tri-state buffer for enabling the multiple-level startup signal to have the first enable level according to the first internal signal when the second enable signal is enabled; and
a second tri-state buffer for enabling the multiple-level startup signal to have the second enable level according to the second internal signal when the first enable signal is enabled.
